(19) United States
(12) Patent Application Publication
(10) Pub. No.: US 2011/0217087 A1
(43) Pub. Date: Sep. 8, 2011

(54) TONER SUPPLY DEVICE, IMAGE FORMING APPARATUS AND METHOD FOR ARRANGING TONER SUPPLY DEVICE

(75) Inventor: Atsushi MIYASHIMA, Shizuoka-ken (JP)

(73) Assignees: Kabushiki Kaisha Thoshiba, Tokyo (JP); Toshiba Tec Kabushiki Kaisha, Tokyo (JP)

(21) Appl. No.: 13/031,007

(22) Filed: Feb. 18, 2011

Related U.S. Application Data
(60) Provisional application No. 61/310,176, filed on Mar. 3, 2010.

(30) Foreign Application Priority Data
Dec. 9, 2010 (JP) P2010-274450

(51) Int. Cl. G03G 15/08

(52) U.S. Cl. 399/258

(57) ABSTRACT

According to one embodiment, a toner supply device includes a plurality of conveyor tubes, each of which has a first supply hole at a receiving side to receive toner, a second supply hole to communicate with a developing device, and a conveying portion to convey the toner supplied from the first supply hole at the receiving side to the second supply hole, wherein each of the first supply holes at the receiving side is arranged at a position with a different angle assuming each of the second supply holes as an axis, a plurality of toner cartridges, each of which houses toner of a different color, and has a first supply hole at a supply side to supply the toner, wherein each of the toner cartridge is located at a position shifted in a predetermined direction so that each of the first supply holes at the supply side communicates with each of the first supply holes at the receiving side of the conveyor tubes, and a plurality of transmitting portions, each of which transmits power to each of the conveying portions of the conveyor tubes.

### CROSS-REFERENCE TO RELATED APPLICATIONS

This application is based upon and claims the benefit of priority from the prior U.S. patent application Ser. No. 61/310,176, filed on Mar. 3, 2010, the entire contents of which are incorporated herein by reference.

This application is also based upon and claims the benefit of priority from Japanese Patent Application No. 2010-274450, filed on Dec. 9, 2010, the entire contents of which are incorporated herein by reference.

### FIELD

Exemplary embodiments described herein relate to a toner supply device, an image forming apparatus and a method for arranging a toner supply device.

### BACKGROUND

In a tandem system color image forming apparatus, developing devices and toner cartridges are arranged so that respective intervals become equal. And the position relations of first toner supply holes of the toner cartridges and second toner supply holes of the developing devices are the same for each color, and toner conveyor tubes of shapes having same diameter for each color are provided so as to connect the first toner supply holes of the toner cartridges and the second toner supply holes of the developing devices, respectively.

On the other hand, owing to circumstances of the layout of peripheral components such as a sheet discharge tray and a fixing device, there is also a case in which intervals between the developing devices and intervals between the toner cartridges are different. In this time, as the position relations of the first toner supply holes of the toner cartridges and the second toner supply holes of the developing devices are different for each color, the respective lengths of the toner conveyor tubes are made different. Accordingly, because such a construction like this is required, a plurality of different components are required.

### BRIEF DESCRIPTION OF THE DRAWINGS

FIG. 1 is a construction view showing an image forming apparatus in a first embodiment;

FIG. 2 is a view showing an image forming portion in the first embodiment;

FIG. 3 is a front view showing .a toner supply device in the first embodiment;

FIG. 4 is a perspective view showing the toner supply device in the first embodiment;

FIG. 5 is a view showing position relations between first toner supply holes and second toner supply holes in the first embodiment;

FIG. 6 is a side view showing the toner supply device in the first embodiment;

FIG. 7 is a top view showing toner cartridges and developing devices in the first embodiment;

FIG. 8 is a view showing an internal construction of a toner conveyor tube in the first embodiment;

FIG. 9 is a perspective view showing a power transmitting portion in the first embodiment;

FIG. 10 is an enlarged view of the power transmitting portion and the toner conveyor tube in the first embodiment;

FIG. 11 is a view showing a curved toner conveyor tube in the first embodiment; and

FIG. 12 is a top view showing toner cartridges and developing devices in a second embodiment.

### DETAILED DESCRIPTION

In general, according to one embodiment, there is provided a toner supply device including: a plurality of conveyor tubes, each of which has a first supply hole at a receiving side to receive toner, a second supply hole to communicate with a developing device, and a conveying portion to convey the toner supplied from the first supply hole at the receiving side to the second supply hole, each of the first supply holes at the receiving side being arranged at a position with a different angle assuming each of the second supply holes as an axis; a plurality of toner cartridges, each of which houses toner of a different color, and has a first supply hole at a supply side to supply the toner, each of the toner cartridge being located at a position shifted in a predetermined direction so that each of the first supply holes at the supply side communicates with each of the first supply holes at the receiving side of the conveyor tubes; and a plurality of transmitting portions, each of which transmits power to each of the conveying portions of the conveyor tubes.

Hereinafter, embodiments of a toner supply device will be described with reference to the accompanying drawings.

### First Embodiment

In a first embodiment, in case that intervals between developing devices and intervals between toner cartridges are different in a tandem system color image forming apparatus, toner conveyor tubes are arranged with angles, and the toner cartridges are at positions which are shifted from a normal position, respectively. Here, the normal position indicates a position where the toner conveyor tube is arranged without angle and the toner cartridge is not shifted in the longitudinal direction.

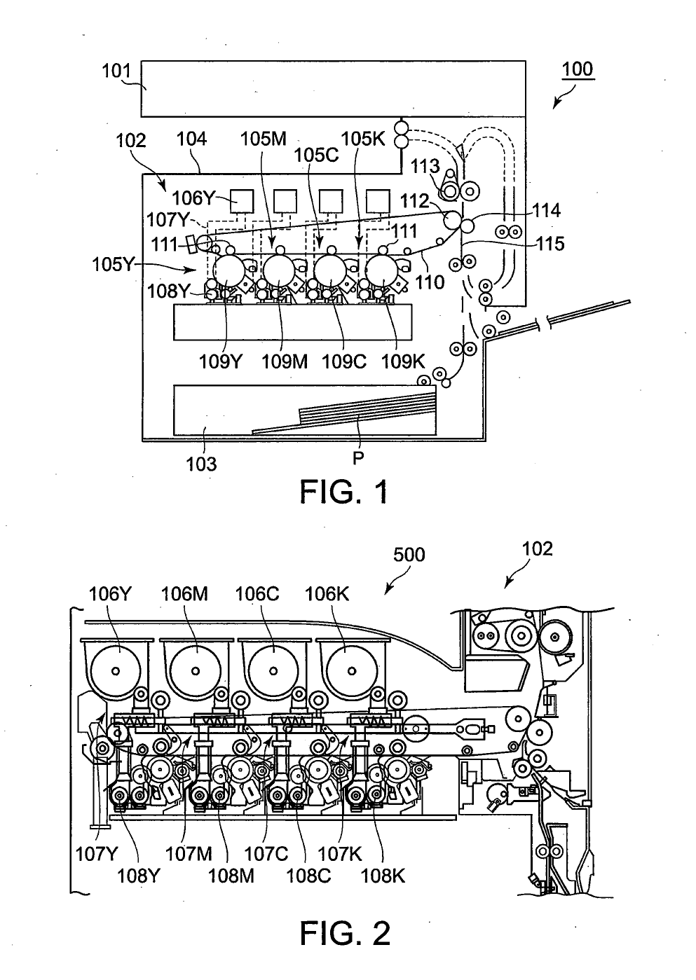

FIG. 1 shows an internal construction of an image forming apparatus 100 of a first embodiment.

The image forming apparatus 100 includes a scanner 101, an image forming portion 102, a sheet cassette (sheet supply portion) 103 and a sheet discharger 104. The scanner 101 reads out an image on a document as image data by scanning the document face optically. The sheet cassette 103 houses a print medium P. The sheet discharger 104 houses the discharged print medium on which the image was formed.

The scanner 101 is an example of an input portion for a printed document, and in addition to this, to receive a document made up by a PC (Personal Computer) as an external terminal at the input portion and print the image on the document as an image data is possible, for example.

The image forming portion 102 forms an image based on the image data on the print medium P. The image forming portion 102 has an image forming unit including four image forming stations 105Y, 105M, 105C and 105K of yellow (Y), magenta (M), cyan (C) black (K), respectively, which are arranged in parallel along a lower side of an intermediate transfer belt 110.

Each of the image forming stations 105Y, 105M, 105C and 105K has the same construction. Accordingly, the construction and function will be described with respect to the image forming station 105Y for yellow use, and with respect to the other image forming stations, corresponding reference numerals are given, and thereby the description will be omitted.

The image forming station 105Y has a toner cartridge 106Y, a toner conveyor tube 107Y, a developing device 108Y, a photoconductor drum 109Y. The toner cartridge 106Y is a container to house toner, and is detachable. The toner conveyor tube 107Y conveys toner from the toner cartridge 106Y to the developing device 108Y. The developing device 108Y has a yellow two-component developer composed of toner and carrier, for example, and is detachable. The developing device 108Y supplies the yellow toner to an electrostatic latent image on the photoconductor drum 109Y.

The intermediate transfer belt 110 faces and contacts with each of the photoconductor drums 109Y, 109M, 109C and 109K (hereinafter, referred to as 109). At the positions of the intermediate transfer belt 110 facing the photoconductor drums 109, primary transfer rollers 111 are provided so as to primarily transfer the toner images to the intermediate transfer belt 110, respectively. The toner images of each color formed on the respective photoconductors are sequentially transferred on the intermediate transfer belt 110 accompanied by the movement of the intermediate transfer belt 110.

At a secondary transfer portion of the intermediate transfer belt 110, a secondary transfer roller 112 is arranged. At the secondary transfer portion, a secondary transfer bias is applied to a backup roller 114.

While the print medium P is sandwiched and conveyed between the intermediate transfer belt 110 and the backup roller 114, the toner image on the intermediate transfer belt 110 is secondarily transferred on the print medium P. Along the running direction of the print medium P, a fixing device 113 is provided at the downstream of the secondary transfer roller 112. The print medium P supplied from the sheet cassette 103 is conveyed along a conveying path 115 to the fixing device 113 through the secondary transfer roller 112. After the fixing device 113 fixes the image, the print medium P on which the image was fixed is discharged to the sheet discharger 104.

FIG. 2 is an enlarged view of the image forming portion 102. The image forming unit in the image forming portion 102 has a toner supply device 500. The toner supply device 500 has toner cartridges 106Y, 106M, 106C, and 106K (hereinafter, referred to as 106), toner conveyor tubes 107Y, 107M, 107C, and 107K (hereinafter, referred to as 107), and developing devices 108Y, 108M, 108C, and 108K (hereinafter, referred to as 108). Each of the toner cartridges 106 has the similar shape, and is arranged to be shifted in the longitudinal direction. In addition, each of the toner conveyor tubes 107 has the similar shape.

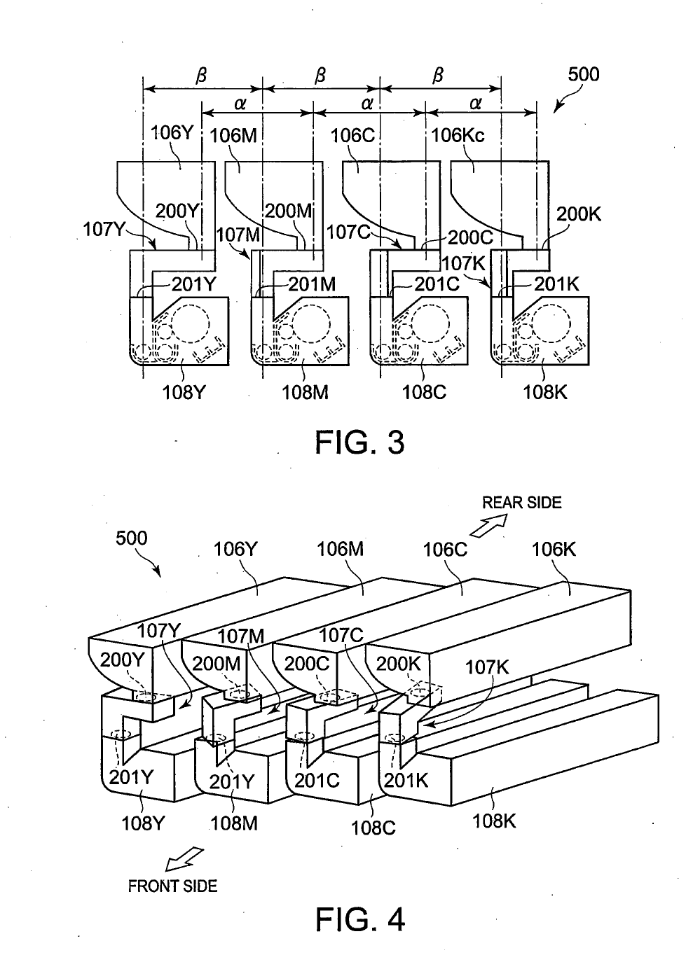

FIG. 3 is a front view of the toner supply device (supply portion) 500. First toner supply holes 200Y are provided at the lower portion of the toner cartridge 106Y and at the upper portion of the toner conveyor tube 107Y. The first toner supply hole 200Y at the lower portion of the toner cartridge 106Y is a first supply hole at the supply side, and the first toner supply hole 200Y at the upper portion of the toner conveyor tube 107Y is a first supply hole at the receiving side. The first supply hole 200Y at the supply side communicates with the first supply hole 200Y at the receiving side, and sponge is provided around the first supply hole 200Y at the receiving side. As the sponge is tightly closed between the first supply hole 200Y at the supply side of the toner cartridge 106Y and the first supply hole 200Y at the receiving side of the toner conveyor tube 107Y, thereby the toner is prevented from scattering. The first supply hole 200Y at the supply side and the first supply hole 200Y at the receiving side are collectively referred to as the first toner supply hole 200Y. The toner is supplied from the toner cartridge 106Y to the toner conveyor tube 107Y through the communicated first toner supply hole 200Y.

Second toner supply holes 201Y are provided at the upper portion of the developing device 108Y and at the lower portion of the toner conveyor tube 107Y. The second toner supply hole 201Y at the lower portion of the toner conveyor tube 107Y is a second supply hole at the supply side, and the second toner supply hole 201Y at the upper portion of the developing device 108Y is a second supply hole at the receiving side. The second supply hole 201Y at the supply side communicates with the second supply hole 201Y at the receiving side, and sponge is provided around the second supply hole 201Y of the supply side. As the sponge is tightly closed between the second supply hole 201Y at the supply side of the toner conveyor tube 107Y and the second supply hole 201Y at the receiving side of the developing device 108Y, thereby the toner is prevented from scattering. The second supply hole 201Y at the supply side and the second supply hole 201Y at the receiving side are collectively referred to as the second toner supply hole 201Y. The toner is supplied from the toner conveyor tube 107Y to the developing device 108Y through the communicated second toner supply hole 201Y.

In case that the intervals between the developing devices 108 and the intervals between the toner cartridges 106 are different, the toner conveyor tubes 107 are arranged with different angles, respectively. Here, the interval indicates an interval between adjacent developing devices 108 or an interval between the adjacent toner cartridges 106. Here, a case is assumed in which the intervals between the toner cartridges 106 and the intervals between the developing devices 108 can not be aligned owing to the layout circumstances of the peripheral components such as the sheet discharger 104 and the fixing device 113. The interval between the adjacent toner cartridges 106 is shorter than the interval between the adjacent developing devices 108, for example. Intervals a may be set to 85 mm which are the interval between the centers of the first supply holes 200Y and 200M, the interval between centers of 200M and 200C, and the interval between the centers of 200C and 200K, for example. Intervals β may be set to 90 mm which are the interval between the centers of the second supply holes 201Y and 201M, the interval between the centers of 201M and 201C, and the interval between the centers of 201C and 201K, for example.

FIG. 4 is a perspective view showing the toner supply device 500. In FIG. 4, the toner conveyor tube 107 of yellow is arranged without angle, and the toner cartridge 106Y is located at the normal position.

The toner conveyor tube 107M is arranged with angle from the normal position assuming the second supply hole 201M as its axis. The level of an angle of the toner conveyor tube 107 from the normal position depends on the intervals between the first supply holes of the plurality of the toner conveyor tubes 107, and the interval between the first supply hole and the second supply hole of the own toner conveyor tube 107.

As shown in FIG. 4, the toner conveyor tube 107M of magenta is arranged with angle to the back side of the toner supply device 500 compared with the toner conveyor tube 107Y of yellow (normal position), the toner conveyor tube 107C of cyan is arranged with angle compared with the toner conveyor tube 107M of magenta, the toner conveyor tube 107K of black is arranged with angle compared with the toner conveyor tube 107C of cyan. With the more angle the toner conveyor tube 107 is arranged to the back side of the toner supply device 500, the more back side the toner cartridge 106 are arranged to.

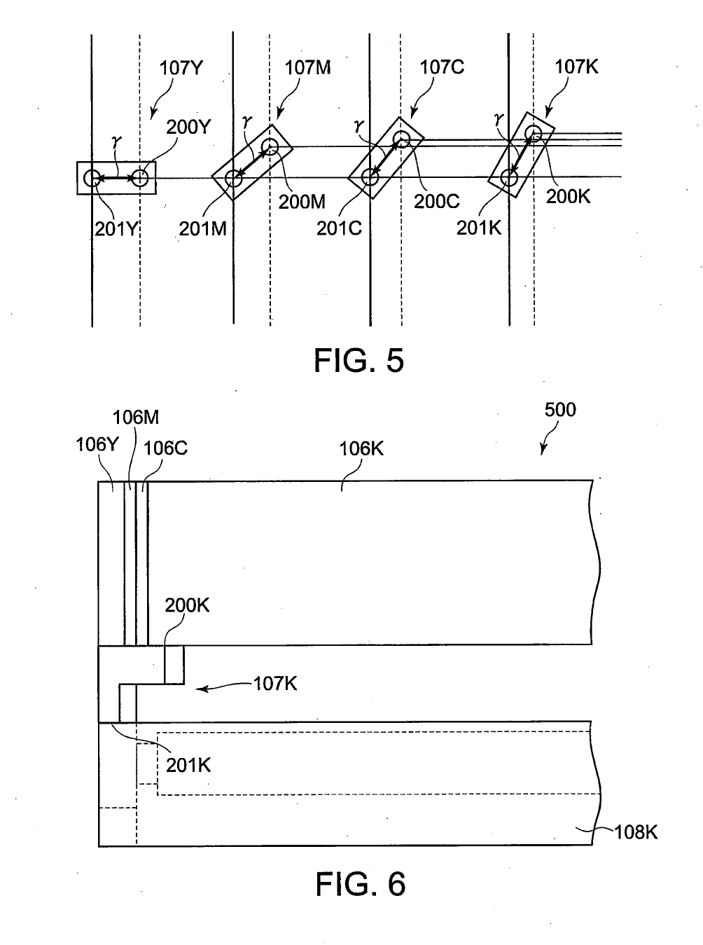

FIG. 5 is a view showing the position relations between the first toner supply holes 200Y, 200M, 200C, 200K (hereinafter referred to as 200) and the second toner supply holes 201Y, 201M, 201C, 201K (hereinafter referred to as 201), respectively. The first toner supply hole 200 and the second toner supply hole 201 are each of a circular shape so as to be arranged with any angle.

The second toner supply holes 201 are fixed, and the intervals between the second toner supply holes 201 are equal, respectively. That is, the intervals between the second toner supply holes 201Y and 201M, between 201M and 201C, and between 201C and 201K are kept equal to each other.

On the other hand, the first toner supply holes 200 are respectively arranged with angles assuming the second supply holes 201 as their axes. Distances between the center points of the first toner supply holes 200 and the center points of the second toner supply holes 201 are equal, with respect to the distances γ between 200Y and 201Y, 200M and 201M, 200C and 201C, 200K and 201K, respectively. That is, even in case that each of the intervals between the toner cartridges 106 and each of the intervals between the developing devices 108 are different, the shapes of the toner conveyor tubes 107 can be made similar, by arranging them with angles assuming the second toner supply holes 201 as their axes, respectively.

FIG. 6 is a side view showing the toner supply device 500. FIG. 6 is the side view in a case seen from the side of the toner cartridge 106K, the toner conveyor tube 107K, and the developing device 108. The toner conveyor tubes 107 are installed with angles, and the toner cartridges 106 are arranged at positions shifted to the back side of the toner supply device 500, respectively. The toner cartridge 106M of magenta is shifted to the back side of the toner supply device 500 compared with the toner cartridge 106Y of yellow (normal position), the toner cartridge 106C of cyan is shifted to the back side of the toner supply device 500 compared with the toner cartridge 106M of magenta, and the toner cartridge 106K of black is shifted to the back side of the toner supply device 500 compared with the toner cartridge 106C of cyan.

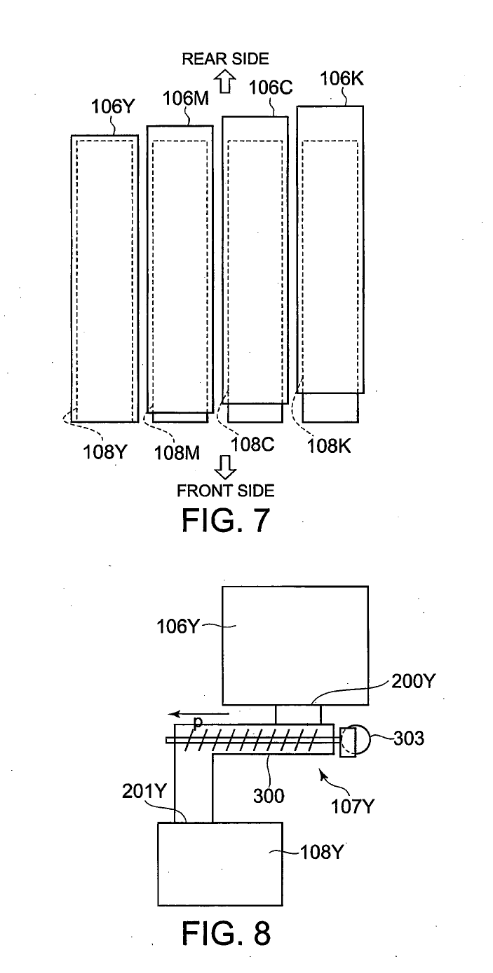

FIG. 7 is a top view showing the toner cartridges 106 and the developing devices 108. As shown in FIG. 7, the developing devices 108 are arranged in fixed state and side by side in the crosswise direction, and the toner cartridges 106 are arranged to be shifted to the back side of the toner supply device 500. The toner cartridge 106Y of yellow is located at the normal position.

FIG. 8 is a view showing an internal construction of the toner conveyor tube 107Y. Here, the toner conveying system of yellow will be described, but the toner conveyor tubes of other magenta, cyan, and black are the same as yellow.

At the inside of the toner conveyor tube 107Y, an auger 300 (conveying portion) in which spiral conveying blades are integrally formed on the outer circumference of the, axis of rotation is rotatably installed. The auger 300 is rotation driven by a drive motor 303 that is driving means which is installed at an end portion of the axis of rotation of the auger 300 by a predetermined amount. The toner which is supplied to the toner conveyor tube 107Y from the toner cartridge 106Y through the supply hole 200Y moves in the direction of an arrow p accompanied with the rotation of the auger 300. If the toner is conveyed to an end portion opposite to the end portion where the drive motor 303 is installed with the rotation of the auger 300, the toner freely falls in the approximately vertical direction, and is replenished to the developing device 108Y via the second toner supply hole 201Y.

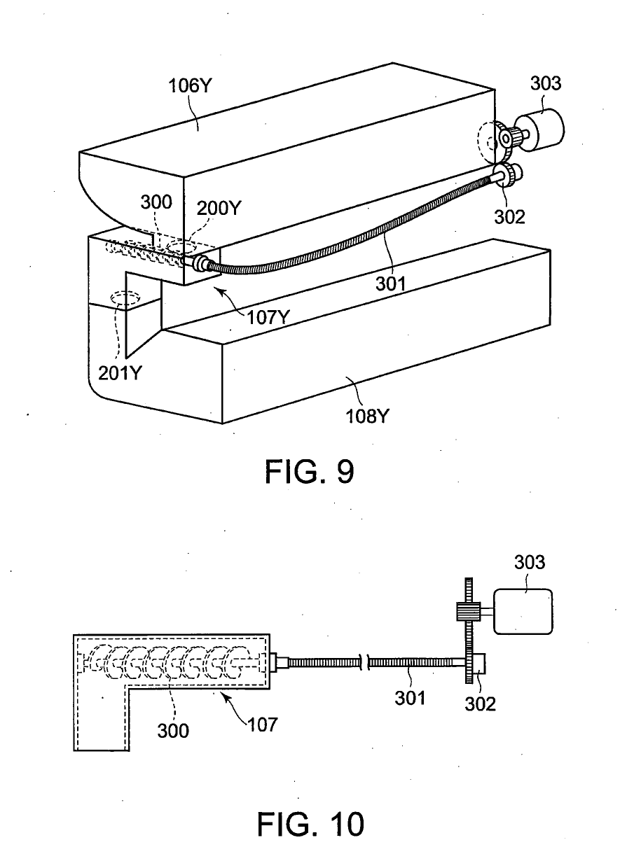

FIG. 9 is a perspective view showing a power transmitting portion. In FIG. 9, the toner conveying system of yellow will be described in the same manner as in FIG. 8. But the toner conveying systems of other magenta, cyan, and black are the same as yellow.

In the first embodiment, the toner cartridges 106 are located at the positions which are shifted to the back side of the toner supply device 500, and the toner conveyor tubes 107 housing the auger 300 are arranged at the positions with angles as shown in FIG. 4 assuming the second supply holes 201Y as their axes, respectively. A flexible shaft 301 which can be moved freely is suitable for the power transmitting portion to transmit the driving from the drive motor 303 via gears 302. FIG. 10 is an enlarged view of the power transmitting portion and the toner conveyor tube.

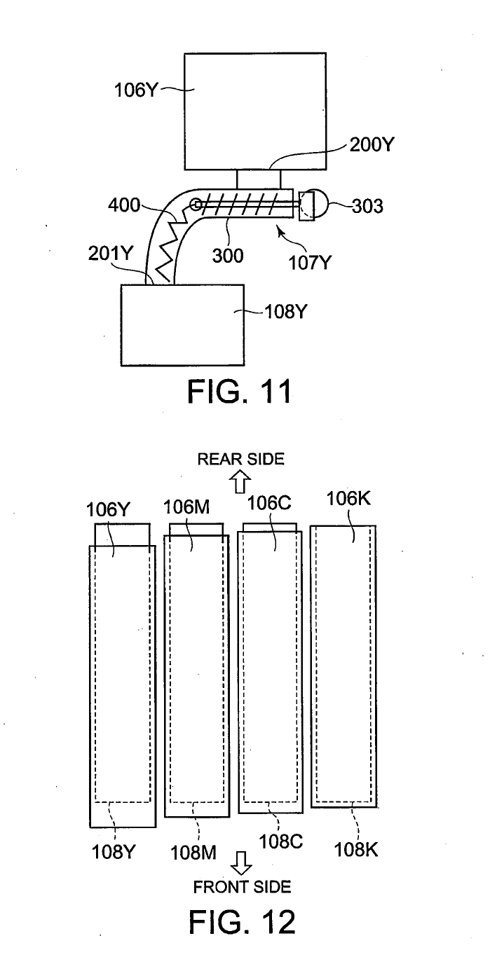

The toner conveyor tube 107 is not limited to a rectangular shape as shown in FIG. 8, but may be a curved toner conveyor tube 107 as shown in FIG. 11. The curved toner conveyor tube 107Y has the auger 300 and a spring agitator 400 (conveying portion). The spring agitator 400 is installed in curved state at the inside of the toner conveyor tube 107Y, and the spring agitator 400 is rotated to convey the toner. The toner supplied to the toner conveyor tube 107Y from the toner cartridge 106Y is conveyed by the conveying portion composed of the auger 300 and the spring agitator 400, and is replenished to the developing device 108Y from the second supply hole 201Y.

The toner cartridges 106 which are located at the position shifted to the back side of the toner supply device 500 and the toner conveyor tubes 107 which are arranged with angles from the normal position are fixed at the time of installing the toner supply device 500. The toner cartridges 106 are fixed by a front cover, but as the toner cartridges 106 are arranged in shifted state to the back side of the toner supply device 500, the front cover is fixed in accordance with the toner cartridges 106, respectively. In addition, the drive motors 303 which are arranged at the back ends of the toner cartridges 106 at the back side of the toner supply device 500 are arranged in accordance with the positions of the toner cartridges 106, respectively.

In the above description, a construction is employed, in which, as shown in FIG. 7, the toner cartridge 106Y of yellow is at the position not to be shifted to the back side of the toner supply device 500, and the toner cartridges 106 which are arranged at further right sides, such as the toner cartridge 106M of magenta, the toner cartridge 106C of cyan, the toner cartridge 106K of black, are shifted more to the back side of the toner supply device 500, respectively. But without being limited to this construction, a construction may be employed in which the toner cartridges 106 which are arranged at further left sides are shifted more to the back side of the toner supply device 500, respectively, or the toner cartridges 106 may be alternately arranged backward and forward, respectively, or may be arranged backward and forward in random order. In addition, a construction may be employed in which at least one toner cartridge out of a plurality of toner cartridges 106 is shifted to the back side of the toner supply device 500.

Using the above-described construction, the toner conveyor tubes with the same shape can be used, and the embodiment can contribute to the reduction in component cost.

In addition the case was described in which the toner cartridges 106 have the same shapes, respectively, but the similar effect can be obtained in a case in which the toner cartridge 106K of black has a larger shape (a length of the longitudinal direction is assumed to be the same) compared with the other toner cartridges 106Y of yellow, 106M of magenta, 106C of cyan.

### Second Embodiment

In a second embodiment, in case that the intervals between developing devices and the intervals between the tone cartridges are different in the tandem system color image forming apparatus, the toner conveyor tubes are arranged with angles, and the toner cartridges are located at positions shifted to the front side, respectively. The same reference numerals are given to the same constituent components as in the first embodiment.

FIG. 12 is a top view showing the toner cartridges 106 and the developing devices 108 in the second embodiment. As shown in FIG. 12, the developing devices 108 are arranged in fixed state and side by side in the crosswise direction, and the toner cartridges 106 are arranged in shifted state to the front side of the toner supply device 500. The toner cartridge 106K of black is located at the normal position.

In the above description, a construction is employed, in which, as shown in FIG. 12, the toner cartridge 106K of black is at the position not to be shifted to the front side of the toner supply device 500, and the toner cartridges 106 which are arranged at further left side, such as the toner cartridge 106C of cyan, the toner cartridge 106M of magenta, the toner cartridge 106Y of yellow, are shifted more to the front side of the toner supply device 500, respectively. But without being limited to this construction, a construction may be employed in which the toner cartridges 106 which are arranged at further right side are shifted more to the front side of the toner supply device 500, respectively, or the toner cartridges 106 may be alternately arranged backward and forward, respectively, or may be arranged backward and forward in random order. In addition, a construction may be employed in which at least one toner cartridge out of a plurality of toner cartridges 106 is shifted to the front side of the toner supply device 500, and the second embodiment may be combined with the first embodiment.

With the above-described construction, even in case that the toner cartridges can not be arranged at the positions shifted to the back side of the toner supply device 500, owing to circumstances of the layout of peripheral components, as the toner cartridges can be arranged at the positions shifted to the front side, the toner conveyor tubes with the same shape can be used, and the embodiment can contribute to the reduction in component cost.

In addition the case was described in which the toner cartridges 106 have the same shapes, respectively, but the similar effect can be obtained in a case in which the toner cartridge 106K of black has a larger shape (a length of the longitudinal direction is assumed to be the same) compared with the other toner cartridges 106Y of yellow, 106M of magenta, and 106C of cyan.

The above-described toner cartridges are each a rectangular shape, but without being limited to this shape, a square shape or a spherical shape may be used.

While certain embodiments have been described, these embodiments have been presented by way of example only, and are not intended to limit the scope of the inventions. Indeed, the novel devices, and apparatus and methods described herein may be embodied in a variety of other forms; furthermore, various omissions, substitutions and changes in the form of the devices, apparatus and methods described herein may be made without departing from the spirit of the inventions. The accompanying claims and their equivalents are intended to cover such forms or modifications as would fall within the scope and spirit of the inventions.

What is claimed is:

1. A toner supply device comprising:
a plurality of conveyor tubes, each of which has a first supply hole at a receiving side to receive toner, a second supply hole to communicate with a developing device, and a conveying portion to convey the toner supplied from the first supply hole at the receiving side to the second supply hole, each of the first supply holes at the receiving side being arranged at a position with a different angle assuming each of the second supply holes as an axis;
a plurality of toner cartridges, each of which houses toner of a different color, and has a first supply hole at a supply side to supply the toner, each of the toner cartridge being located at a position shifted in a predetermined direction so that each of the first supply holes at the supply side communicates with each of the first supply holes at the receiving side of the conveyor tubes; and
a plurality of transmitting portions, each of which transmits power to each of the conveying portions of the conveyor tubes.

2. The device of claim 1, wherein the first supply hole at the supply side and the first supply hole at the receiving side to communicate the toner cartridge with the conveyor tube are each circular, and the second supply hole to communicate the conveyor tube with the developing device is circular.

3. The device of claim 1, wherein the angle with which the position of the first supply hole at the receiving side of the conveyor tube is arranged, assuming the second supply hole as the axis, depends on intervals between the first supply holes at the receiving side of the plurality of conveyor tubes, and an interval between the first supply hole at the receiving side and the second supply hole of the own toner conveyor tube.

4. The device of claim 1, wherein the power transmitting portion is movable freely.

5. The device of claim 4, wherein the power transmitting portion is a flexible shaft.

6. The device of claim 1, wherein the toner cartridge has a rectangular shape, and the first supply hole at the supply side of the toner cartridge is located at a position shifted to a back side in the longitudinal direction.

7. The device of claim 1, wherein the toner cartridge has a rectangular shape, and the first supply hole at the supply side of the toner cartridge is located at a position shifted to a front side in the longitudinal direction.

8. The device of claim 1, wherein the toner cartridge has a rectangular shape, and the first supply holes at the supply side of the toner cartridges include the first supply hole at the supply side at a position shifted to a back side in the longitudinal direction and the first supply hole at the supply side at a position shifted to a front side in the longitudinal direction.

9. The device of claim 1, wherein the conveyor tube is of a shape including L shape below the toner cartridge and above the developing device.

10. The device of claim 1, wherein the conveyor tube is of a curved shape below the toner cartridge and above the developing device.

11. An image forming apparatus comprising:
a sheet supply portion to supply a print medium;
a plurality of conveyor tubes, each of which has a first supply hole at a receiving side to receive toner, a second supply hole to communicate with a developing device, and a conveying portion to convey the toner supplied from the first supply hole at the receiving side to the second supply hole, each of the first supply holes at the receiving side being arranged at a position with a different angle assuming each of the second supply holes as an axis;
a plurality of toner cartridges, each of which houses toner of a different color and has a first supply hole at a supply side to supply the toner, wherein each of the toner cartridge is located at a position shifted in a predetermined direction so that each of the first supply holes at the supply side communicates with each of the first supply holes at the receiving side of the conveyor tubes;
a plurality of transmitting portions, each of which transmits power to each of the conveying portions of the conveyor tubes; and
an image forming portion to form an image on the print medium supplied from the sheet supply portion with the toner which is supplied from the toner cartridge.

12. A method for arranging a toner supply device comprising:
arranging a plurality of conveyor tubes with different angles, each of which has a first supply hole at a receiving side to receive toner, a second supply hole to communicate with .a developing device, and a conveying portion to convey the toner supplied from the first supply hole at the receiving side to the second supply hole;
arranging a plurality of toner cartridges, each of which houses toner of a different color and has a first supply hole at a supply side to supply the toner, at positions shifted in predetermined directions, so that each of the first supply holes at the supply side communicates with each of the first supply holes at the receiving side of the conveyor tubes; and
transmitting power to the conveying portions of the conveyor tubes by a plurality of power transmitting portions, respectively.
